(19) United States
(12) Patent Application Publication
(10) Pub. No.: US 2016/0019657 A1
(43) Pub. Date: Jan. 21, 2016

(54) ANALYSIS OF E-RECEIPTS TO DETERMINE POSSIBLE EXCEPTIONS

(71) Applicant: BANK OF AMERICA COPORATION, CHARLOTTE, NC (US)

(72) Inventor: Christian Michael Mande, Charlotte, NC (US)

(21) Appl. No.: 14/333,646

(22) Filed: Jul. 17, 2014

(51) Int. Cl. G06Q 40/00

(52) U.S. Cl. CPC G06Q 40/12; G06Q 40/02

(57) ABSTRACT

Disclosed is an aggregation computing system and associated method for determining exceptions in purchase level data and online banking data. The system typically includes an online banking database that has online banking data associated with a first customer account, the online banking data including first transaction information associated with a first transaction. The aggregation computing system also typically includes an aggregation module that is configured for: receiving second transaction information associated with a second transaction by a customer using the first customer account, the second transaction information comprising purchase level data; comparing the second transaction information with the online banking data associated with the first customer account; based on comparing the second transaction information with the online banking data, identifying an exception; and graphically presenting within an online banking interface an indication of the exception.

### FIELD OF THE INVENTION

The present invention embraces an aggregation computing system for determining exceptions in purchase level data and online banking data. The aggregation computing system typically includes a processor, a memory, and an aggregation module stored in the memory. The aggregation module is typically configured for comparing received purchase level data associated with a transaction with online banking data associated with one or more transactions. The aggregation module typically determines if the purchase level data is associated with a transaction included in the online banking data. The aggregation module also typically determines if an exception exists (e.g., a discrepancy between the purchase level data and the online banking data).

### BACKGROUND

Over the last few years, there has been an increase in the amount of electronic information provided by merchants to customers regarding purchases of products and services. A need exists for an improved way of organizing and utilizing this electronic information regarding purchases of products and services.

### SUMMARY

In one aspect, the present invention embraces a method for determining exceptions in purchase level data and online banking data. The present invention also embraces a system (e.g., an aggregation computing system) configured for performing one or more of the steps of the method.

The system typically has an online banking database including online banking data associated with a first customer account, the online banking data including first transaction information associated with a first transaction. In operation, the system receives second transaction information associated with a second transaction by a customer using the first customer account, the second transaction information including purchase level data. The second transaction information is then compared with the online banking data associated with the first customer account. Based on comparing the second transaction information with the online banking data, an exception is identified. An indication of the exception is then graphically presenting within an online banking interface (e.g., to the customer).

In a particular embodiment, identifying the exception includes determining that a discrepancy exists between the first transaction information and the second transaction information.

In another particular embodiment, identifying the exception includes determining that the online banking database does not possess purchase level data associated with the first transaction.

In yet another particular embodiment, identifying the exception includes determining that a merchant or merchant location included with the second transaction information is not associated with a previous transaction associated with the first customer account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts an aggregation computing system, online banking system, and environment in accordance with an aspect of the present invention;

FIG. 2 depicts a method for integrating purchase level data with online banking data and determining any exceptions that exist in the online banking data and/or the purchase level data in accordance with an aspect of the present invention;

FIG. 3 depicts a method determining any exceptions that exist in online banking data in accordance with a particular aspect of the present invention;

FIG. 4 schematically depicts a customer's computing device in accordance with an aspect of the present invention;

FIG. 5 schematically depicts an aggregation computing system in accordance with an aspect of the present invention; and

FIG. 6 schematically depicts an online banking system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution. In this regard, other businesses can take the place of or work in conjunction with the financial institution to perform one or more of the processes or steps described herein as being performed by a financial institution. Still in other embodiments of the invention the financial institution described herein may be replaced with other types of businesses that offer payment account systems to customers.

As used herein, an “online banking account” is an account that is associated with one or more user accounts at a financial institution. For example, the user may have an online banking account that is associated with the user's checking account, savings account, prepaid account, investment account, and credit account at a particular financial institution (e.g., the financial institution providing the online banking account). In some embodiments, the user's online banking account at a particular financial institution may also provide the user with access and information regarding user accounts that are maintained other financial institutions. For example, the user may provide a first financial institution with login information associated with the user's online banking account at a second financial institution. A username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). In other embodiments, the “customer” may refer to the user.

Furthermore, the term “electronic receipt” or “e-receipt” as used herein may include any electronic communication between a merchant and a customer, where the communication is associated with a transaction. In this way, e-receipts may include information about the transaction, such as location of purchase, the transaction total, order confirmations, shipping confirmations, item description, SKU data, merchant name, merchant address, merchant web address, order number, order date, product or service description, product or service name, product or service quantity, product or service price, product image, hyperlink to the product image on merchant website, sales tax, shipping cost, order total, billing address, shipping company, shipping address, estimated shipping date, estimated delivery date, tracking number, and the like.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

In the past few years, there has been an increase in the amount of electronic information provided by merchants to customers regarding purchases of items (e.g., products and/or services). In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase. The order confirmation includes detailed information regarding the products or services purchased. For example, in the case of a product or service, the order confirmation may include stock keeping unit “SKU” code level data, as well as other parameters, such as order number, order date, product or service description, product or service name, product or service quantity, product or service price, product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. For most online transactions, the merchant will send at least one second communication confirming shipment of the order. The order shipment confirmation is typically also sent via email to the customer and typically includes the same information as the order confirmation, and in addition, shipping date, tracking number, and other relevant information regarding the order and shipment parameters.

Many merchants now also provide e-receipts to customers shopping at brick and mortar locations. In general, at the point of sale, the customer may have previously configured or may be asked at the time of sale as to whether she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

For the most part, order confirmations, shipping confirmations, e-receipts, and other electronic communications between merchants and customers are used only by the customer as proof of purchase and for monitoring receipt of purchased items (e.g., for archival purposes). However, there is significant data that can be gleaned from this electronic information for the benefit of the customer, so that the customer may have detailed information regarding purchase history, spending, and the like.

Another development in the past few years has been the growth of online banking, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manage finances. A current drawback with online banking is that transactional level detail for a given purchase by the customer is limited. Despite the large amount of information sent by merchants to customers regarding purchases, merchants currently do not provide purchase details to financial institutions. The only information typically provided to the financial institution is information about the merchant and an overall transaction amount. For example, if a financial institution customer purchases several clothing items from a merchant and uses a financial institution debit card, credit card or check, all that is provided to the financial institution is merchant level data (e.g., merchant information and overall purchase price). Item level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budget tools. In general, budget tools divide expenses into various categories, such as food, clothing, housing, transportation, and the like. It is typically advantageous to provide such budget tools with online banking information to populate these various categories with spend information. However, this is difficult where specifics regarding a purchase made by the merchant (e.g., SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations.

Customer cash purchases are also problematic for the integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (e.g., SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data to obtain an understanding of the details of a given purchase transaction.

In light of the above, the current invention contemplates use of e-receipt data and other electronic communication data between a merchant and customer regarding a transaction in order to augment purchase transaction data in online banking. The general concept is to retrieve such electronic communications from the customer, parse the data in these electronic communications, and associate the data from the electronic communications with the corresponding online purchase transaction data.

An initial barrier to integration of electronic communication data received by a customer from a merchant regarding a purchase transaction for inclusion into online banking is data format. Online banking data is in a structured form. Financial institutions currently use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply to a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form. exception

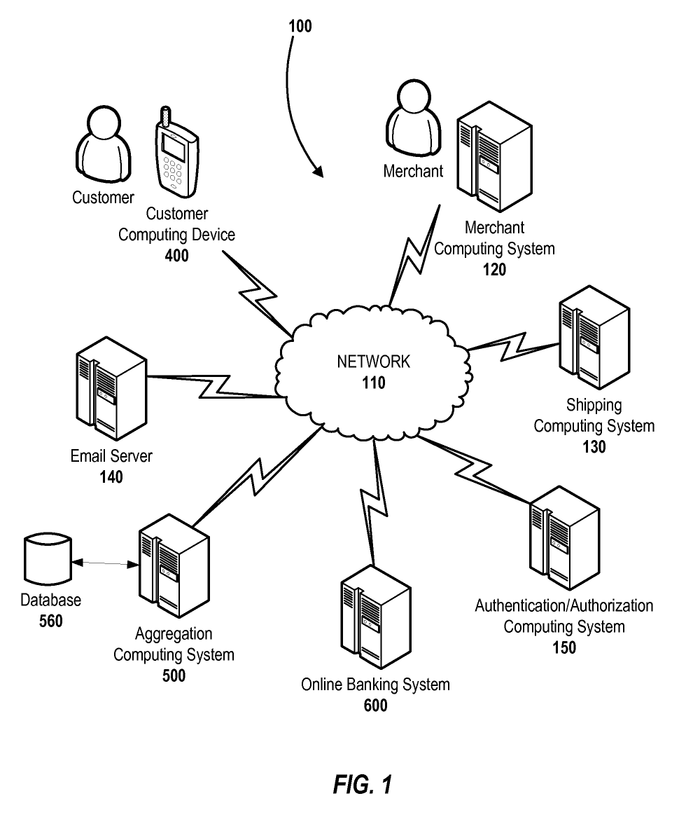

FIG. 1 is a diagram of an operating environment 100 according to one embodiment of the present invention for retrieval of electronic communications relating to customer purchase transactions, parsing of data within such electronic communications into structured data, and inclusion of such data into online banking. As illustrated a consumer maintains one or more computing devices 400, such as a PC, laptop, mobile phone, tablet, television, mobile device, or the like that is network enabled for communicating across a network 110, such as the Internet, wide area network, local area network, Bluetooth network, near field network, or any other form of contact or contactless network. Also, the operating environment 100 includes one or more merchant computing systems 120 that is network enabled. In the context of an online shopping experience, the merchant computing system 120 may be one or more financial transaction servers that, either individually or working in concert, are capable of providing web pages to a customer via the network 110, receiving purchase orders for items selected by the customer, communicating with the customer and third party financial institutions to secure payment for the order, and transmitting order confirmation, and possibly shipping confirmation information, to the customer via the network 110 regarding the purchase transaction. In the context of an in-store purchase, the merchant computing system 120 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as SKU code level data, as well as other parameters associated with the product or service, such as type/category, size, color, and the like, as well purchase price information, information associated with the merchant, and the like. The merchant computing system may also send other subsequent communications, such as communications confirming shipment of the order, which typically includes the same information as the purchase order confirmation, and in addition, shipping date, tracking number, and other relevant information regarding the order. In the context of an in-store purchase, the merchant computing system may send an e-receipt including information similar to that of the purchase order confirmation. In some instances, the customer may actually receive a paper receipt, which the customer may choose to scan into an electronic form and save in a storage device associated with the customer computing device 400. In further instances, a paper receipt may include a quick response (QR) code having SKU level data embedded therein. Such a QR code may be scanned and read by a customer's mobile device. In the description herein, the term e-receipt may be used generically to refer to any communication or document provided by a merchant to a customer relating to a purchase transaction.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 400, or in an email server 140, or in a customer's account at the merchant's computing system 120. Furthermore, as mentioned, the purchase transaction related information is in an unstructured format. Each merchant may use a customized reporting format for the communications, whereby various data relating to the purchase transaction may be placed in different sequences, different locations, different formats, and the like for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, the operating environment further includes an aggregation computing system 500, which may be operated by a financial institution. The aggregation computing system 500 is operatively connected to at least one of the customer computing device 400, the merchant computing system 120, and the email server 140 via the network 110. The aggregation computing system is configured to initially search and locate electronic communications associated with purchase transactions made by the customer, in for example, the customer's email, computer storage device, online accounts, and the like. For this purpose, the system may optionally include an authentication/authorization computing system 150 that includes security IDs and passwords and other security information associated with the customer for accessing customer's email, storage devices, and customer online accounts.

Regarding email extraction, aggregation computing system 500 initially gains access to the customer's email accounts and retrieves email message headers including data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 500. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: (i) a text order confirmation template; (ii) an HTML order confirmation template; (iii) a text shipping confirmation template; and (iv) an HTML shipping confirmation template. Where the email is an e-receipt from a brick and mortar purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, or e-receipt data. As mentioned, a customer may scan and save paper receipts typed or handwritten notes, invoices, bills of sale, and the like in a storage device or print and save purchase order and shipping confirmation communications sent to the customer by the merchant via a web page. In this instance, the aggregation computing system 500 may first perform optical character recognition “OCR” on the scanned or printed receipts prior to performing the processing performed above. If a paper receipt includes a QR code having embedded SKU level data, such a QR code may be scanned, read, and saved by a customer's mobile device. Further, a customer may maintain an online account with a merchant containing purchase data information. In this instance, the aggregation computing system 500 will access the data online via communication with merchant computing system to retrieve this data. The aggregation computing system 500 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant) (Details about order) (Details about item 1) (Details about item 2) . . . (Details about item N) (Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 500 to parse the email message bodies, e-receipt bodies, online data, etc. to extract the entities of interest from them. Examples of such extracted entities include merchant name, merchant web address, order number, order date, product or service description, product or service name, product or service quantity, product or service price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system may use these tags to identify the shipping and/or tracking information for extraction.

Once relevant information is extracted from communications between the customer and merchant regarding purchase transactions, it is stored in purchase data records in a structured database 560.

As is understood, once the purchase transaction data has been extracted, various information regarding a particular purchase transaction is now known, such as merchant name, merchant web address, order number, order date, product or service description, product or service name, product or service quantity, product or service price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping computing system 130, product images, information about product returns, warranty information, recall information, and the like. In particular, the aggregation computing system may (i) communicate with the merchant and/or shipping company to update the shipping and delivery information extracted and stored in the database, (ii) may search the merchant or the web in general to retrieve product images, and/or (iii) communicate with merchant for return policies, warranties, insurance, recalls, and the like.

The above is a description of an aggregation computing system according to one embodiment of the present invention. An example of an aggregation computing system is described in U.S. Published Patent Application No. 2013/0024525 titled Augmented Aggregation of Emailed Product Order and Shipping Information, the contents of which are incorporated herein by reference.

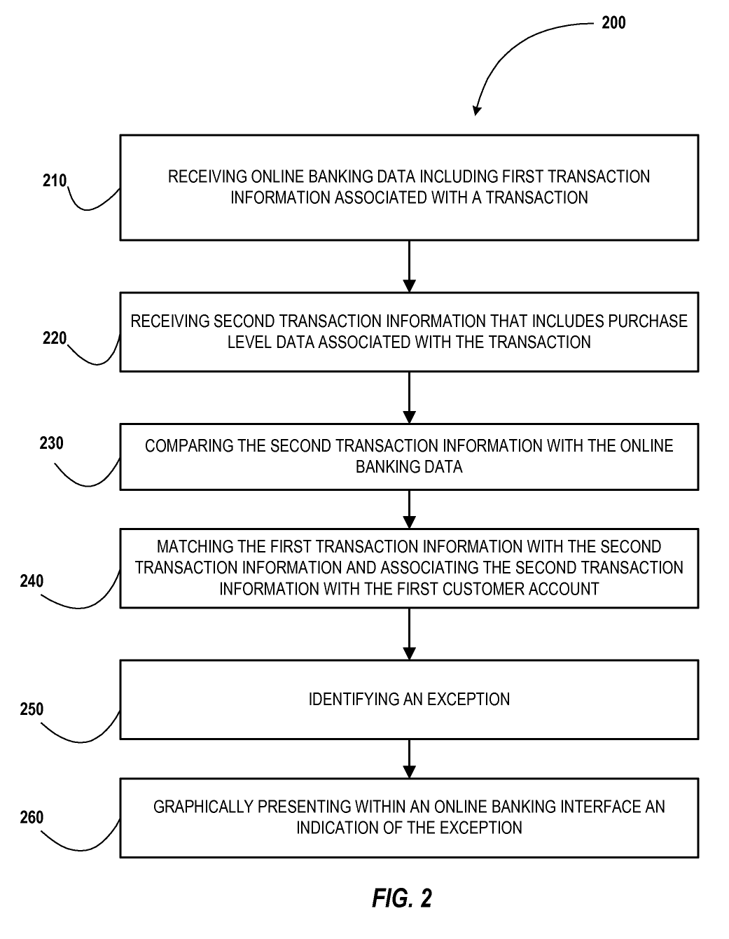

Once the purchase transaction data has been extracted, this information may be integrated into the customer's online banking account. In this regard, the aggregation computing system may be part of or in communication with an online banking system 600, which is typically operated by the financial institution. In a particular embodiment, the present invention embraces an aggregation computing system that is configured to integrate purchase level data (e.g., SKU level data) with online banking data and determine any exceptions that exist in the online banking data and/or the purchase level data. In this regard, FIG. 2 depicts a method 200 of integrating purchase level data with online banking data and determining any exceptions that exist in the online banking data and/or the purchase level data.

At block 210, the aggregation computing system 500 and/or online banking system 600 receives online banking data. The online banking data is typically received from an online banking database, which may be part of the aggregation computing system 500 and/or online banking system 600. The online banking data typically includes first transaction information associated with a transaction (e.g., purchase) involving an account (e.g., a debit account, checking account, or credit account) of the customer. The first transaction information typically includes merchant level data (i.e., data typically sent by a merchant involved in a transaction to the financial institution providing the customer's account), such as transaction date, transaction amount, merchant name, and identification information related to the customer's first customer account (e.g., account number). Merchant level data typically does not include purchase level data. In some embodiments, the first transaction information may include information related to cash and/or check transactions such as date of a withdrawal, withdrawal amount, check date, and check amount. Although, merchant level data typically does not include purchase level data, the first transaction information may include purchase level data previously integrated into the online banking data.

At block 220, the aggregation computing system 500 and/or online banking system 600 receives second transaction information that includes purchase level data (i.e., data that includes information regarding the purchase of individual items) associated with the transaction, such as item price, item name, item description, item brand, SKU data (e.g., the item's SKU code), and any other information particular to each item or service purchased. Purchase level data also typically includes data similar to merchant level data. Accordingly, purchase level data typically includes transaction date, transaction amount, merchant information (e.g., merchant name and/or location), and identification information related to the customer's account. The second transaction information typically includes unstructured data from an e-receipt, a QR code included on a receipt, a receipt image (e.g., a receipt image that has been processed using OCR technology), an order confirmation, and/or a shipping confirmation. In this regard, the system may monitor the customer's email account, social network account, or the like to identify communications from a merchant that are associated with a recent customer transaction and extract purchase level data included therein.

Next, at block 230, the second transaction information is compared with the online banking data (e.g., using the aggregation computing system 500). Typically, the second transaction information is compared with the online banking data to determine if the second transaction information corresponds to transaction information included in the online banking data. In this regard, the aggregation computing system 500 may recognize that some data in the second transaction information, such as the transaction date, transaction amount, and/or merchant name, corresponds to related data in the first transaction information.

If data in the second transaction information sufficiently corresponds to data in the first transaction information, then, at block 240, the first transaction information is matched with the second transaction information (e.g., using the aggregation computing system 500), thereby indicating that the first transaction information and the second transaction information refer to the same transaction. In addition, the second transaction information is typically associated with the first customer account and integrated with the online banking data (e.g., by adding the second transaction information to the online banking data and storing the second transaction information in the online banking database). In some embodiments, the aggregation computing system 500 may match purchase level data in the second transaction information with a cash or check transaction information included in the online banking data (e.g., by using the date of a withdrawal, withdrawal amount, check date, and/or check amount).

At block 250, the aggregation computing system 500 and/or online banking system 600 identifies if an exception (e.g., an anomalous or exceptional event) exists in the online banking data.

In one embodiment, an exception exists if there is a discrepancy between merchant level data and purchase level data associated with the same transaction. For example, merchant level data and purchase level data associated with the same transaction may have inconsistent transaction totals, transaction dates, and/or merchant information. Accordingly, the aggregation computing system 500 and/or online banking system 600 may determine that a discrepancy exists between the first transaction information and the second transaction information.

In another embodiment, an exception exists if the transaction is associated with (e.g., conducted with) a new merchant or new merchant location. In this regard, the aggregation computing system 500 and/or online banking system 600 may compare the merchant information (e.g., merchant name and/or location) included in the first transaction information and/or the second transaction information regarding the transaction against merchant information associated with previous transactions included in the online banking data. If the merchant name or merchant location associated with the transaction does not match the merchant information associated with any previous transaction, then an exception exists.

Based on identifying an exception, at block 260, an indication of the exception is graphically presented to the customer. For example, the indication of the exception may be graphically presented to the customer within an online banking interface provided to the customer by the online banking system 600 through an online banking website (e.g., a mobile banking website) that the customer accesses via a web browser on the customer computing device 400 or through an online banking application on the customer computing device 400. In this regard, the online banking website and/or online banking application may present a graphical user interface (GUI) that displays information regarding one or more transactions associated with the customer's online banking account and purchase level data regarding those transactions (e.g., purchase level data extracted from one or more e-receipts). Within the online banking interface, an icon or other graphical indicator of the exception may be presented overlaying or adjacent to the transaction information associated with the exception. The characteristics of the icon or other graphical indicator may be defined by the financial institution. Alternatively, the characteristics (e.g., color, shape, and the like) of the icon or other graphical indicator may be defined by the customer (e.g., using an online banking interface). In another embodiment, the indication of the exception may be graphically presented to the customer by sending the customer an alert (e.g., via an email, instant message, social media message, or SMS message). The financial institution and/or customer may define the frequency that such alerts are sent to the customer and/or the method of sending such alerts (e.g., email, instant message, social media message, or SMS message)

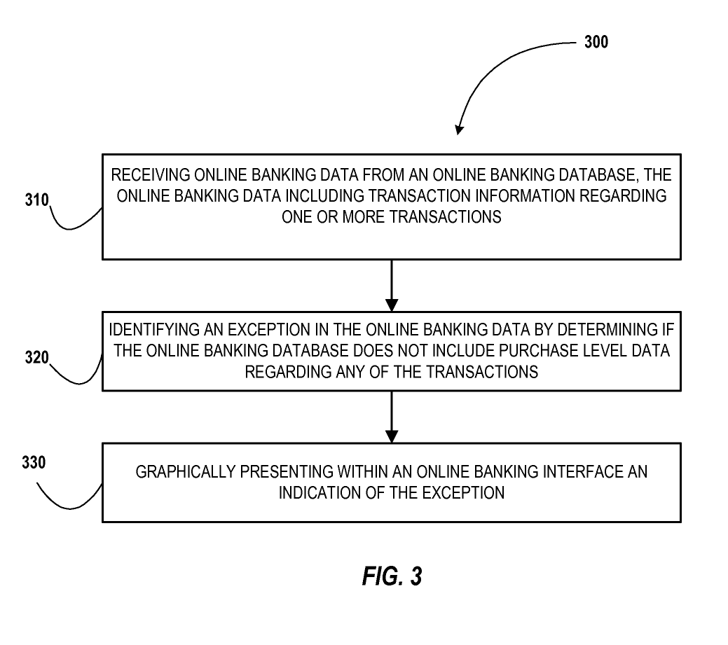

In accordance with a particular embodiment of the present invention, FIG. 3 depicts a method 300 of identifying exceptions in online banking data, where an exception exists if the online banking data does not include purchase level data for a transaction included in the online banking data.

At block 310, the aggregation computing system 500 and/or online banking system 600 receives online banking data. The online banking data is typically received from an online banking database, which may be part of the aggregation computing system 500 and/or online banking system 600. The online banking data typically includes information regarding one or more transactions. This transaction information typically includes merchant level data regarding the transactions. This transaction information also typically includes purchase level data regarding one or more of transactions (e.g., purchase level data previously integrated into the online banking data).

At block 320, the aggregation computing system 500 and/or online banking system 600 identifies if one or more exceptions exist in the online banking data by determining if any transactions included in the online banking data do not have associated purchase level data. In this regard, the aggregation computing system 500 and/or online banking system 600 typically determines if the online banking database includes purchase level data for each transaction. If the online banking database does not include purchase level data for a particular transaction, then, typically, such purchase level data has not yet been received or was not successfully integrated into the online banking data.

At block 330, an indication of the exception is graphically presented to the customer. For example, the indication of the exception may be graphically presented to the customer within an online banking interface provided to the customer by the online banking system 600 through an online banking website (e.g., a mobile banking website) that the customer accesses via a web browser on the customer computing device 400 or through an online banking application on the customer computing device 400. In this regard, the online banking website and/or online banking application may present a graphical user interface (GUI) that displays information regarding one or more transactions associated with the customer's online banking account and purchase level data regarding those transactions (e.g., purchase level data extracted from one or more e-receipts). An icon or other graphical indicator of the exception may be presented overlaying or adjacent to the transaction information associated with the exception. Alternatively, the indication of the exception may be graphically presented to the customer by sending the customer an email, instant message, social media message, or SMS message.

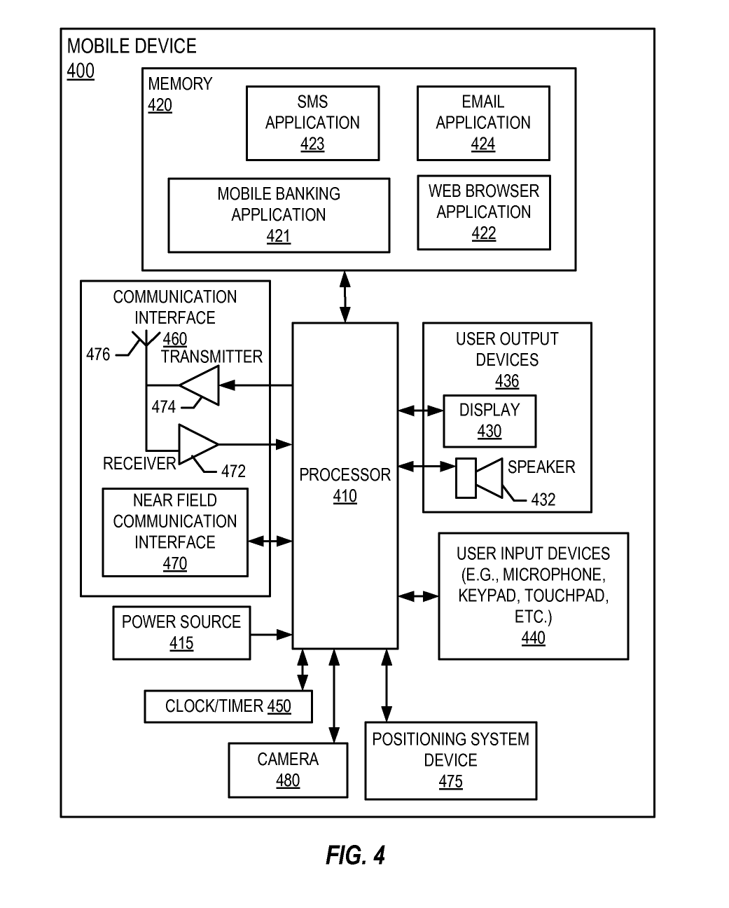

FIGS. 4-6 depict the computing device 400, aggregation computing system 500, and online banking system 600 in more detail. The computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, a tablet computer, a laptop, or other mobile device. FIG. 4 depicts the computing device 400 as being a mobile device 400

In general, the mobile device 400 is configured to connect with the network 110 to log the customer into an online banking system 600. The online banking system 600 involves authentication of the customer in order to access the customer's account on the online banking system 600. For example, the online banking system 600 is a system where the customer logs into his/her account such that the customer can access data that is associated with the customer. For example, in one embodiment of the invention, the system 600 may be an online banking system maintained by a financial institution. In such an embodiment, the customer can use the mobile device 400 to log into the online banking system 600 to access the customer's online banking account. Logging into the online banking system 600 generally requires that the customer authenticate his/her identity using a user name, a passcode, a cookie, a biometric identifier, a private key, a token, and/or another authentication mechanism that is provided by the customer to the online banking system 600 via the mobile device 400.

In one embodiment, an application download server may be used to download software applications that support the online banking system 600 to the mobile device 400 and/or computing device 500.

In some embodiments of the invention, the application download server is configured to be controlled and managed by one or more third-party data providers over the network 110. In other embodiments, the application download server is configured to be controlled and managed over the network 110 by the same entity that maintains the online banking system 600.

FIG. 4 provides a block diagram illustrating the mobile device 400 of FIG. 1 in more detail, in accordance with embodiments of the invention. In one embodiment of the invention, the mobile device 400 is a mobile telephone. However, it should be understood, however, that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, cameras, video recorders, audio/video player, radio, GPS devices, or any combination of the aforementioned.

The mobile device 400 typically includes a processor 410 communicably coupled to such devices as a memory 420, user output devices 436, user input devices 440, a communication interface 460, a power source 415, a clock or other timer 450, a camera 480, and a positioning system device 475. The processor 410, and other processors described herein, typically includes circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is typically configured to use the communication interface 460 to communicate with one or more other devices on the network 110. In this regard, the communication interface 460 typically includes an antenna 476 operatively coupled to a transmitter 474 and a receiver 472 (together a “transceiver”). The processor 410 is typically configured to provide signals to and receive signals from the transmitter 474 and receiver 472, respectively. The signals may include signaling information in accordance with the air interface standard of the applicable cellular system of the wireless telephone network 352. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The communication interface 460 may also include a near field communication (NFC) interface 470. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 470 may include a smart card, key card, proximity card, Bluetooth® device, radio frequency identification (RFID) tag and/or reader, transmitter, receiver, and/or the like. In some embodiments, the NFC interface 470 communicates information via radio, infrared (IR), and/or optical transmissions. In some embodiments, the NFC interface 470 is configured to operate as an NFC transmitter and/or as an NFC receiver (e.g., an NFC reader). Also, it will be understood that the NFC interface 470 may be embedded, built, carried, and/or otherwise supported in and/or on the mobile device 400. In some embodiments, the NFC interface 470 is not supported in and/or on the mobile device 400, but the NFC interface 470 is otherwise operatively connected to the mobile device 400 (e.g., where the NFC interface 470 is a peripheral device plugged into the mobile device 400). Other apparatuses having NFC interfaces mentioned herein may be configured similarly. In some embodiments, the NFC interface 470 of the mobile device 400 is configured to contactlessly and/or wirelessly communicate information to and/or from a corresponding NFC interface of another apparatus (e.g., another mobile or computing device).

The mobile device 400 typically has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400 to receive data from a user such as the customer, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a location to determine that the mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which include computer-executable instructions/code executed by the processor 410 to implement the functions of the mobile device 400 described herein. For example, the memory 420 may include such applications as a conventional web browser application 422 and/or a mobile banking application 421. These applications also typically provide a graphical user interface (GUI) on the display 430 that allows the customer to communicate with the consumer mobile device 400, the online banking system 600, and/or other devices or systems. In one embodiment of the invention, when the customer decides to enroll in the online banking program, the customer downloads or otherwise obtains the mobile banking system client application from the online banking system 600 or from a distinct application server. In other embodiments of the invention, the customer interacts with the online banking system 600 via the web browser application 422 in addition to, or instead of, the mobile banking application 421. The online banking system 600 is typically configured to present a graphical user interface (e.g., through a mobile banking application or mobile banking website) that allows the customer to view transaction information (e.g., purchase level data) using the mobile device 400.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information.

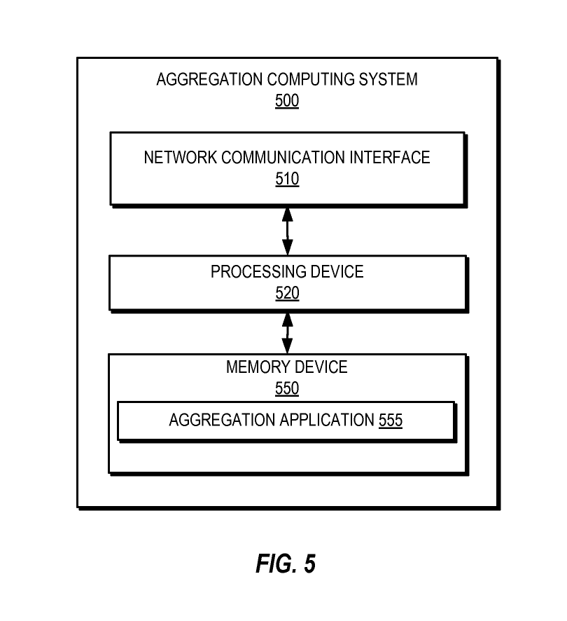

Referring now to FIG. 5, the aggregation computing device 500 includes various features, such as a network communication interface 510, a processing device 520, and a memory device 550. The network communication interface 510 includes a device that allows the aggregation computing device 500 to communicate over the network 110 (shown in FIG. 1). An aggregation application 555 stored in the memory device 550 may be configured to (i) extract unstructured purchase level data from an e-receipt, a receipt image, an order confirmation, and/or a shipping confirmation, (ii) convert this purchase level data into a structured format, and (iii) match this purchase level data with transaction information (e.g., merchant level data) from the online banking system 600. Once extracted, the aggregation application 555 may store the purchase level data in purchase data records in a database in the aggregation computing device 500 and/or online banking system 600.

As used herein, a “processing device,” such as the processing device 520, generally refers to a device or combination of devices having circuitry used for implementing the communication and/or logic functions of a particular system. For example, a processing device 520 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 may further include functionality to operate one or more software programs based on computer-executable program code thereof, which may be stored in a memory. As the phrase is used herein, a processing device 520 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device,” such as the memory device 550, generally refers to a device or combination of devices that store one or more forms of computer-readable media for storing data and/or computer-executable program code/instructions. Computer-readable media is defined in greater detail below. For example, in one embodiment, the memory device 550 includes any computer memory that provides an actual or virtual space to temporarily or permanently store data and/or commands provided to the processing device 520 when it carries out its functions described herein.

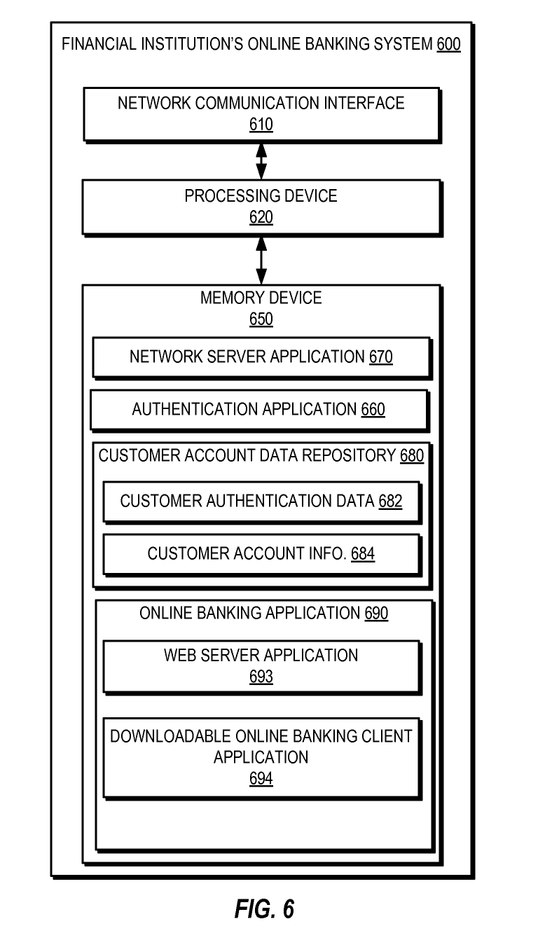

FIG. 6 provides a block diagram illustrating the online banking system 600 in greater detail, in accordance with an embodiment of the invention. As illustrated in FIG. 6, in one embodiment of the invention, the online banking system 600 includes a processing device 620 operatively coupled to a network communication interface 610 and a memory device 650. In certain embodiments, the online banking system 600 is operated by a financial institution, while in other embodiments, the online banking system 600 is operated by an entity other than a financial institution.

It should be understood that the memory device 650 may include one or more databases or other data structures/repositories. The memory device 650 also includes computer-executable program code that instructs the processing device 620 to operate the network communication interface 610 to perform certain communication functions of the online banking system 600 described herein. For example, in one embodiment of the online banking system 600, the memory device 650 includes, but is not limited to, a network server application 670, an authentication application 660, a customer account data repository 680 which includes customer authentication data 680 and customer account information 684, an online banking application 690 which includes a web server application 693, a downloadable online banking client application 694, and other computer-executable instructions or other data. The computer-executable program code of the network server application 670, the authentication application 660, or the online banking application 690 may instruct the processing device 620 to perform certain logic, data-processing, and data-storing functions of the online banking system 600 described herein, as well as communication functions of the online banking system 600.

In one embodiment, the customer account data repository 680 includes customer authentication data 682 and customer account information 684. The customer account data repository typically includes an online banking database having information (e.g., merchant level data and/or purchase level data) regarding transactions involving the customer's account(s). The network server application 670, the authentication application 660, and the online banking application 690 are configured to implement customer account information 684 and the customer authentication data 682 (e.g., customer identification information) when authenticating a customer to the online banking system 600. In this regard, the customer authentication data 682 may include a customer's username, password, PIN number, and/or other authenticating information. The customer account information 684 may include account identification information.

As used herein, a “communication interface” typically includes a modem, server, transceiver, and/or other device for communicating with other devices on a network, and/or a user interface for communicating with one or more customers. Referring again to FIG. 6, the network communication interface 610 is a communication interface having one or more communication devices configured to communicate with one or more other devices on the network 110, such as the mobile device 400, the computing device 500, and the online banking system 600. The processing device 620 is typically configured to use the network communication interface 610 to transmit and/or receive data and/or commands to and/or from the other devices connected to the network 110.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. An aggregation computing system for determining exceptions in purchase level data and online banking data, comprising:
a computer apparatus including a processor and a memory;
an online banking database stored in the memory, the online banking database comprising online banking data associated with a first customer account, the online banking data comprising first transaction information associated with a first transaction; and
an aggregation module stored in the memory, executable by the processor and configured for:
receiving second transaction information associated with a second transaction by a customer using the first customer account, the second transaction information comprising purchase level data;
comparing the second transaction information with the online banking data associated with the first customer account;
based on comparing the second transaction information with the online banking data, identifying an exception; and
graphically presenting within an online banking interface an indication of the exception.

2. The aggregation computing system according to claim 1, wherein:
the aggregation module is configured for, based on comparing the second transaction information with the online banking data, determining that the second transaction and the first transaction are the same transaction and associating the second transaction with the first customer account; and
identifying the exception comprises determining that a discrepancy exists between the first transaction information and the second transaction information.

3. The aggregation computing system according to claim 2, wherein determining that the discrepancy exists between the first transaction information and the second transaction information comprises determining that a first transaction total included in the first transaction information differs from a second transaction total included in the second transaction information.

4. The aggregation computing system according to claim 1, wherein identifying the exception comprises determining that the online banking database does not possess purchase level data associated with the first transaction.

5. The aggregation computing system according to claim 1, wherein:
the second transaction information comprises information regarding a merchant associated with the second transaction; and
identifying the exception comprises determining that the merchant is not associated with a previous transaction associated with the first customer account.

6. The aggregation computing system according to claim 1, wherein:
the second transaction information comprises information regarding a merchant location associated with the second transaction; and
identifying the exception comprises determining that the merchant location is not associated with a previous transaction associated with the first customer account.

7. A computer program product for determining exceptions in purchase level data and online banking data, comprising a non-transitory computer-readable storage medium having computer-executable instructions for:
receiving second transaction information associated with a second transaction by a customer using the first customer account, the second transaction information comprising purchase level data;
comparing the second transaction information with online banking data associated with the first customer account, the online banking data being included in an online banking database, the online banking data comprising first transaction information associated with a first transaction;
based on comparing the second transaction information with the online banking data, identifying an exception; and
graphically presenting within an online banking interface an indication of the exception.

8. The computer program product according to claim 7, wherein:
the non-transitory computer-readable storage medium has computer-executable instructions for, based on comparing the second transaction information with the online banking data, determining that the second transaction and the first transaction are the same transaction and associating the second transaction with the first customer account; and
identifying the exception comprises determining that a discrepancy exists between the first transaction information and the second transaction information.

9. The computer program product according to claim 8, wherein determining that the discrepancy exists between the first transaction information and the second transaction information comprises determining that a first transaction total included in the first transaction information differs from a second transaction total included in the second transaction information.

10. The computer program product according to claim 7, wherein identifying the exception comprises determining that the online banking database does not possess purchase level data associated with the first transaction.

11. The computer program product according to claim 7, wherein:
the second transaction information comprises information regarding a merchant associated with the second transaction; and
identifying the exception comprises determining that the merchant is not associated with a previous transaction associated with the first customer account.

12. The computer program product according to claim 7, wherein:
the second transaction information comprises information regarding a merchant location associated with the second transaction; and
identifying the exception comprises determining that the merchant location is not associated with a previous transaction associated with the first customer account.

13. A method for determining exceptions in purchase level data and online banking data, comprising:
receiving, via a computer processor, second transaction information associated with a second transaction by a customer using the first customer account, the second transaction information comprising purchase level data;
comparing, via a computer processor, the second transaction information with online banking data associated with the first customer account, the online banking data being included in an online banking database, the online banking data comprising first transaction information associated with a first transaction;
based on comparing the second transaction information with the online banking data, identifying, via a computer processor, an exception; and
graphically presenting, via a computer processor, within an online banking interface an indication of the exception.

14. The method according to claim 13, comprising, based on comparing the second transaction information with the online banking data, determining that the second transaction and the first transaction are the same transaction and associating the second transaction with the first customer account;
wherein identifying the exception comprises determining that a discrepancy exists between the first transaction information and the second transaction information.

15. The method according to claim 14, wherein determining that the discrepancy exists between the first transaction information and the second transaction information comprises determining that a first transaction total included in the first transaction information differs from a second transaction total included in the second transaction information.

16. The method according to claim 13, wherein identifying the exception comprises determining that the online banking database does not possess purchase level data associated with the first transaction.

17. The method according to claim 13, wherein:
the second transaction information comprises information regarding a merchant associated with the second transaction; and
identifying the exception comprises determining that the merchant is not associated with a previous transaction associated with the first customer account.

18. The method according to claim 13, wherein:
the second transaction information comprises information regarding a merchant location associated with the second transaction; and
identifying the exception comprises determining that the merchant location is not associated with a previous transaction associated with the first customer account.
